(19) United States
(12) Patent Application Publication
(10) Pub. No.: US 2022/0410180 A1
(43) Pub. Date: Dec. 29, 2022

(54) SPRAY APPARATUS FOR IMPROVING PERFORMANCE OF RECTANGULAR-SHAPED SCRUBBER

(71) Applicant: HANBAL MASSTECH LIMITED, Gimhae-si, Gyeongsangnam-do (KR)

(72) Inventors: Ki Joon KANG, Ulsan (KR); Sung Won LEE, Gimhae-si, Gyeongsangnam-do (KR)

(21) Appl. No.: 17/780,775

(22) PCT Filed: Dec. 2, 2020
(86) PCT No.: PCT/KR2020/017472

§ 371 Date: May 27, 2022

(30) Foreign Application Priority Data
Dec. 27, 2019 (KR) 10-2019-0176888

(51) Int. Cl. B05B 1/02; B05B 1/20; B01D 53/18

(52) U.S. Cl. CPC B05B 1/02; B05B 1/20; B01D 53/185; B01D 2252/103

(57) ABSTRACT

The present disclosure relates to a spray apparatus for improving the performance of a rectangular-shaped scrubber which may efficiently remove harmful substances in a gas by mounting an injector for spraying a liquid in a rectangular pyramid shape on a scrubber having a rectangular shape. The spray apparatus includes: a scrubber having a rectangular shape; and an injector mounted on the scrubber and including a spray nozzle configured to spray a liquid in a rectangular pyramid shape.

### TECHNICAL FIELD

The present disclosure relates to a spray apparatus for improving the performance of a rectangular-shaped scrubber, and more particularly, to a spray apparatus for improving the performance of a rectangular-shaped scrubber which may efficiently remove harmful substances in a gas by mounting an injector for spraying a liquid in a rectangular pyramid shape on a scrubber having a rectangular shape.

### BACKGROUND ART

In general, a device for burning fuel such as a turbine or a heater used in a fertilizer factory, a chemical plant, a ship, etc. discharges an exhaust gas to the atmosphere. Before the exhaust gas is discharged to the atmosphere, a scrubber that is a type of column absorbs harmful substances such as soot and sulfur compounds to meet environmental emission standards and then discharges the exhaust gas to the atmosphere.

A scrubber includes a packing column, a tray column, or a spray column, or includes a combination thereof, and sprays a liquid and chemicals into the scrubber so that a gas introduced into the scrubber comes into contact with the liquid and the chemicals to remove harmful substances. In this case, an injector for spraying the liquid into the scrubber plays an important role in efficient contact between the liquid and the gas.

The injector should be designed so that the liquid efficiently contacts the gas rising from the bottom of the scrubber or introduced from the top of the scrubber, to increase the efficiency of removing harmful substances.

In detail, when the liquid sprayed by the injector does not cover the scrubber generating an empty space or an area where liquids sprayed from a plurality of injectors overlap one another increases, contact efficiency between the liquid(s) and the gas is reduced.

### DESCRIPTION OF EMBODIMENTS

### Technical Problem

To solve the problems, the present disclosure relates to a spray apparatus for improving the performance of a rectangular-shaped scrubber which may efficiently remove harmful substances by mounting an injector for spraying a liquid in a rectangular pyramid shape on a scrubber having a rectangular shape.

### Solution to Problem

According to the present disclosure, a spray apparatus for improving the performance of a rectangular-shaped scrubber includes: a scrubber having a rectangular shape; and an injector mounted on the scrubber and including a spray nozzle configured to spray a liquid in a rectangular pyramid shape.

Each of corners of the scrubber having the rectangular shape may contact a side of a base of a rectangular pyramid formed by a liquid sprayed by the injector.

The injector may include a plurality of spray nozzles, wherein a plurality of injectors are provided, and the plurality of injectors are arranged in a same plane.

A separation space between bases of rectangular pyramids formed by liquids spayed by the plurality of spray nozzles may be less than 10% of an area of the bases of the rectangular pyramids formed by the liquids sprayed by the plurality of spray nozzles.

Bases of rectangular pyramids formed by liquids sprayed by adjacent spray nozzles may overlap one another.

A spray angle of a liquid sprayed by the spray nozzle of the injector may range from 10° to 150°.

The injector may be configured to spray a liquid upward or downward.

The injector may include a first injector configured to spray a liquid upward and a second injector configured to spray a liquid downward.

The scrubber may include a filler or a tray for removing harmful substances, wherein a distance between the spray nozzle and the filler or the tray is greater than 0.1 m.

A distance between the spray nozzle and a surface of a liquid formed on a lower portion of the scrubber may be greater than 0.3 m.

A distance between the spray nozzle and a bottom of a lower portion of the scrubber or a liquid outlet on the lower portion of the scrubber may be greater than 0.3 m.

A liquid injection pressure of the spray nozzle may range from 0.1 bar to 30 bar.

The injector may be mounted on the scrubber while forming a plurality of layers.

### Advantageous Effects of Disclosure

According to the present disclosure relating to a spray apparatus for improving the performance of a rectangular-shaped scrubber, because an injector for spraying a liquid in a rectangular pyramid shape is mounted on a scrubber having a rectangular shape, harmful substances in a gas may be efficiently removed.

Also, according to the present disclosure, because an injector for spraying a liquid in a rectangular pyramid shape is mounted on a scrubber having a rectangular shape, a portion of the scrubber not covered by the liquid sprayed by the injector may be minimized.

Also, according to the present disclosure, because an injector for spraying a liquid in a rectangular pyramid shape is mounted on a scrubber having a rectangular shape, an area where liquids sprayed by a plurality of injectors overlap one another may be minimized, a liquid sprayed onto an inner wall surface of the scrubber may be minimized, contact efficiency between a liquid and a gas may be improved, and thus, harmful substances may be efficiently removed.

### BRIEF DESCRIPTION OF DRAWINGS

FIG. 1 is a view illustrating a spray nozzle of an injector.

FIG. 2 is a view illustrating an effective distance a, a spray angle b, and a theoretical coverage c of a liquid sprayed by a spray nozzle.

FIG. 3A is a view illustrating a spray nozzle for spraying a liquid in a conical shape. FIG. 3B is a view illustrating a spray nozzle for spraying a liquid in a rectangular pyramid shape.

FIG. 4 is a view illustrating an injector for spraying a liquid to a scrubber having a circular cross-section.

FIG. 5A is a view illustrating the use of a spray nozzle for spraying a liquid in a conical shape to a scrubber having a circular cross-section. FIG. 5B is a view illustrating the use of a spray nozzle for spraying a liquid in a conical shape to a scrubber having a rectangular cross-section.

FIG. 6 is a view illustrating a distribution quality for determining contact efficiency between a liquid and a gas.

FIG. 7 is a view illustrating a spray apparatus for improving the performance of a rectangular-shaped scrubber according to an embodiment of the present disclosure.

FIG. 8 is a view illustrating a state where injectors having the same length and each including a plurality of spray nozzles are arranged in the same plane according to an embodiment of the present disclosure.

FIGS. 9A and 9B are views illustrating the use of a spray nozzle for spraying a liquid in a rectangular pyramid shape for a scrubber having a rectangular cross-section according to an embodiment of the present disclosure.

### MODE OF DISCLOSURE

Principles and embodiments of the present disclosure will be described in detail in order to fully convey the scope of the present disclosure and enable one of ordinary skill in the art to embody and practice the present disclosure. The embodiments may be implemented in various forms.

As used in various embodiments of the present disclosure, the expressions “include,” “may include” and other conjugates refer to the existence of a corresponding disclosed function, operation, or constituent element, and do not limit one or more additional functions, operations, or constituent elements. Further, as used in various embodiments of the present disclosure, the terms “include,” “have” and their conjugates may be construed to denote a certain feature, number, step, operation, constituent element, component, or a combination thereof, but may not be construed to exclude the existence of or a possibility of addition of one or more other features, numbers, steps, operations, constituent elements, components, or combinations thereof.

When a component is referred to as being “connected” or “coupled” to any other component, it should be understood that the component may be directly connected or coupled to the other component, but another new component may also be interposed between them. In contrast, when a component is referred to as being “directly connected” or “directly coupled” to any other component, it should be understood that there is no new component between the component and the other component.

It will be understood that although the terms “first,” “second,” etc. may be used herein to describe various elements, these elements should not be limited by these terms. The above terms are used only to distinguish one component from another.

The present disclosure relates to a spray apparatus for improving the performance of a rectangular-shaped scrubber, and more particularly, relates to a spray apparatus for improving the performance of a rectangular-shaped scrubber which may efficiently remove harmful substances in a gas by mounting an injector for spraying a liquid in a rectangular pyramid shape on a scrubber having a rectangular shape.

The spray apparatus for improving the performance of a rectangular-shaped scrubber according to an embodiment of the present disclosure will be described in detail with reference to the attached drawings.

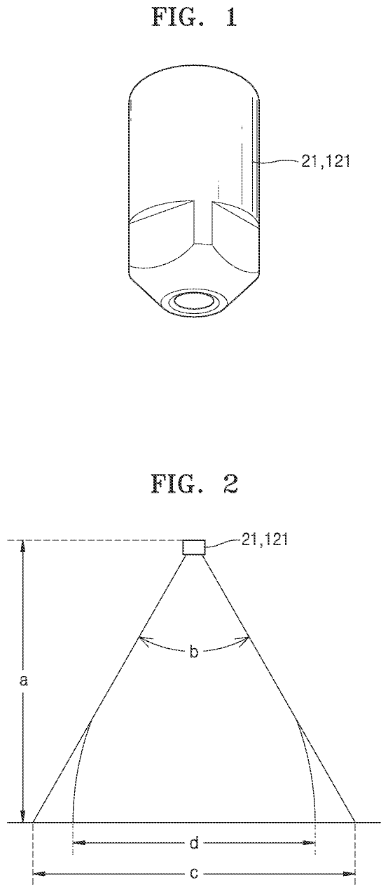

In order to remove harmful substances in a gas, injectors 20 and 120 including spray nozzles 21 and 121 are used, and FIG. 1 illustrates the spray nozzles 21 and 121. A liquid for removing harmful substances may be sprayed from the spray nozzles 21 and 121, and the harmful substances may be removed through contact between the liquid and a gas.

Referring to FIG. 2, the spray nozzles 21 and 121 disperse a liquid and spray the liquid while forming a spray angle b. When the dispersed liquid exceeds an effective distance a, the liquid gradually falls vertically while being lowered by gravity, and a width at which the liquid is sprayed in the effective distance a becomes a theoretical coverage c. (That is, the effective distance a may indicate a distance by which the liquid is dispersed and falls.)

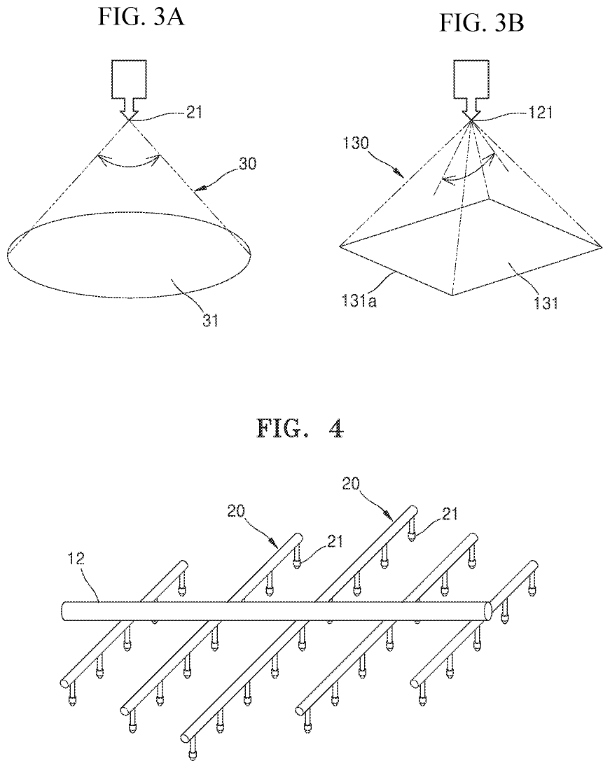

Referring to FIG. 3A, the spray nozzle 21 may spray a liquid in a conical shape 30, and referring to FIG. 3B, the spray nozzle 121 may spray a liquid in a rectangular pyramid shape 130.

When the liquid is sprayed in the conical shape 30, a height of a cone may be calculated as the effective distance a, and a width (diameter) of a base of the cone may be calculated as the theoretical coverage c. Also, when the liquid is sprayed in the rectangular pyramid shape 130, a height of a rectangular pyramid may be calculated as the effective distance a, and a width of a base of the rectangular pyramid may be calculated as the theoretical coverage c.

However, the present disclosure is not limited thereto, and the width of the base of the cone or the width of the base of the rectangular pyramid may be calculated as a width d at which the liquid is actually sprayed in the effective distance a. Hereinafter, an embodiment of the present disclosure will be described based on the cone and the rectangular pyramid calculated based on the effective distance a and the theoretical coverage c.

The spray apparatus for improving the performance of a rectangular-shaped scrubber according to an embodiment of the present disclosure includes a scrubber 110 and an injector 120.

The scrubber 110 has a rectangular shape, and may be provided as a rectangular barrel into which a gas is injected to remove harmful substances of the gas. When a scrubber for removing harmful substances in an exhaust gas of a power plant, a ship, or the like is installed, if the scrubber has a rectangular shape, a space may be efficiently used.

The spray apparatus for improving the performance of a rectangular-shaped scrubber according to an embodiment of the present disclosure may be applied to a scrubber having a rectangular shape which may improve space efficiency.

The scrubber 110 may remove harmful substances in a gas while the gas is injected, and may be replaced with a column. That is, the scrubber 110 may be of various types as long as it may remove harmful substances in a gas while the gas is injected, and will be described with a unified name as a scrubber.

The spray apparatus for improving the performance of a rectangular-shaped scrubber according to an embodiment of the present disclosure includes the injector 120 for spraying a liquid in a rectangular pyramid shape in order to improve the efficiency of removing harmful substances in the scrubber 110 having a rectangular shape.

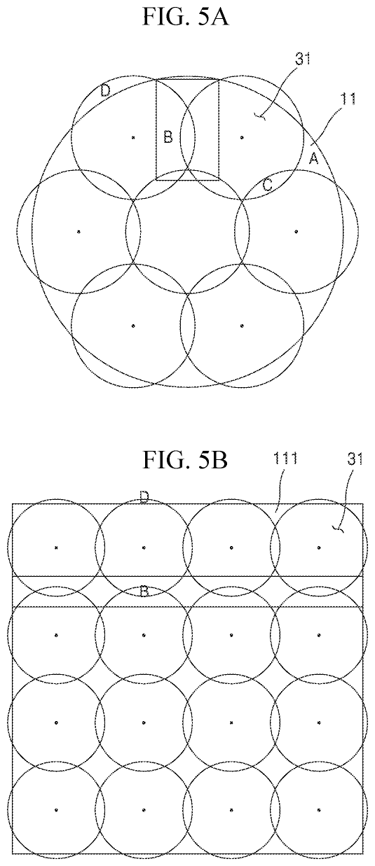

Referring to FIGS. 3A and 4, in the related art, the injector 20 for spraying a liquid in the conical shape 30 is used. In the related art, the injector 20 includes a plurality of spray nozzles 21, and a plurality of injectors 20 having different lengths are coupled to a header pipe 12 to form a circular cross-section 11. In the related art, the spray nozzles 21 for spraying a liquid in the conical shape 30 configured as shown in FIG. 4 are used, and a liquid is sprayed to a scrubber having a circular cross-section as shown in FIG. 5A. (The header pipe 12, and the plurality of injectors 20 including the plurality of spray nozzles 21 for spraying a liquid in a conical shape constitute a conventional spray apparatus having a conical shape.)

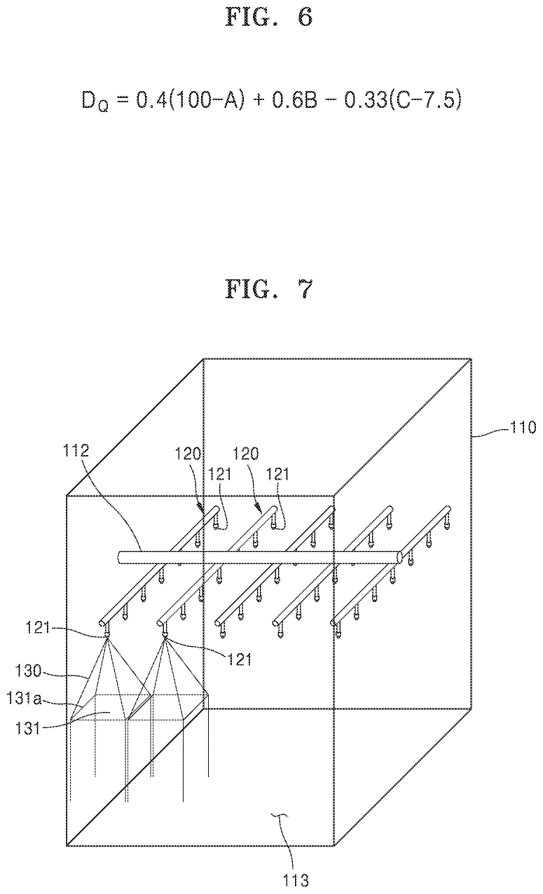

When a liquid sprayed by an injector does not cover a cross-section of a scrubber or a portion where liquids overlap one another increases, contact efficiency between a liquid and a gas is reduced. Distribution performance considering these factors may be expressed as a distribution quality as shown in FIG. 6.

In FIG. 6, a factor related to A indicates a portion not covered by a liquid, a factor related to B indicates a portion where a liquid is sprayed to a worst performing part due to a portion not covered by a liquid and a portion where liquids overlap one another, from among an area corresponding to 1/12 of a cross-sectional area of a scrubber, and a factor related to C indicates a portion where liquids sprayed from adjacent injectors overlap one another.

A size of a droplet sprayed from a spray nozzle of an injector ranges from about 10 μm to 5000 μm, and a gas contacts a surface of the droplet to remove harmful substances. Accordingly, in addition to the factors A, B, and C shown in the distribution quality of FIG. 6, as the amount of liquid (factor D) sprayed to a wall of a scrubber increases, the amount of liquid flowing along the wall of the scrubber increases, and thus, contact efficiency with a gas decreases when the same amount of liquid is sprayed.

That is, contact efficiency between a liquid and a gas may be evaluated according to the factors A, B, C, and D. FIG. 5A illustrates the factors A, B, C, and D when the spray nozzle 21 for spraying a liquid in the conical shape 30 is used in a scrubber having the circular cross-section 11. When the distribution quality of FIG. 6 is applied to FIG. 5A, the distribution quality is 93%, and an area D covered by a liquid sprayed to a wall surface and not effectively contacting a gas is 9% of a cross-sectional area of the scrubber.

Although the spray nozzle 21 for spraying a liquid in the conical shape 30 is applied to the scrubber having the circular cross-section 11 in FIG. 5A, when the spray nozzle 21 for spraying a liquid in the conical shape 30 is applied to the scrubber 110 having a rectangular cross-section 111 as shown in FIG. 5B, contact efficiency between a liquid and a gas is significantly reduced.

In detail, when the distribution quality of FIG. 6 is applied to the FIG. 5B, the distribution quality is 86%, and the area D covered by a liquid sprayed to a wall surface and not effectively contacting a gas is 1.8% of a cross-sectional area of the scrubber. As such, when the spray nozzle 21 for spraying a liquid in the conical shape 30 to the scrubber 110 having a rectangular shape, the factors A, B, C, and D increase and contact efficiency between a liquid and a gas is significantly reduced. (A circle related to a liquid spray area illustrated in FIGS. 5A and 5B indicates a cone base 31 of the conical shape 30.)

To solve the problems, the spray apparatus for improving the performance of a rectangular-shaped scrubber according to an embodiment of the present disclosure uses the injector 120 for spraying a liquid in a rectangular pyramid shape in the scrubber 110 having a rectangular shape.

Referring to FIG. 3B, the injector 120 according to an embodiment of the present disclosure includes the spray nozzle 121 for spraying a liquid in the rectangular pyramid shape 130. Referring to FIG. 7, each of corners of the scrubber 110 having a rectangular shape contacts a side 131a of a base of a rectangular pyramid formed by a liquid sprayed by the injector 120.

A corner of the scrubber 110 having a rectangular shape refers to a corner of a rectangular cross-section of the scrubber 110. A base 131 of a rectangular pyramid may be a base of a rectangular pyramid formed at a position separated by the effective distance a from the spray nozzle 121, and the side 131a of the base of the rectangular pyramid may be a corner provided on the base 131 of the rectangular pyramid.

The injector 120 according to an embodiment of the present disclosure sprays a liquid in the rectangular pyramid shape 130 so that each corner of the scrubber 110 having a rectangular shape contacts the side 131a of the base of the rectangular pyramid, thereby improving contact efficiency between a liquid and a gas.

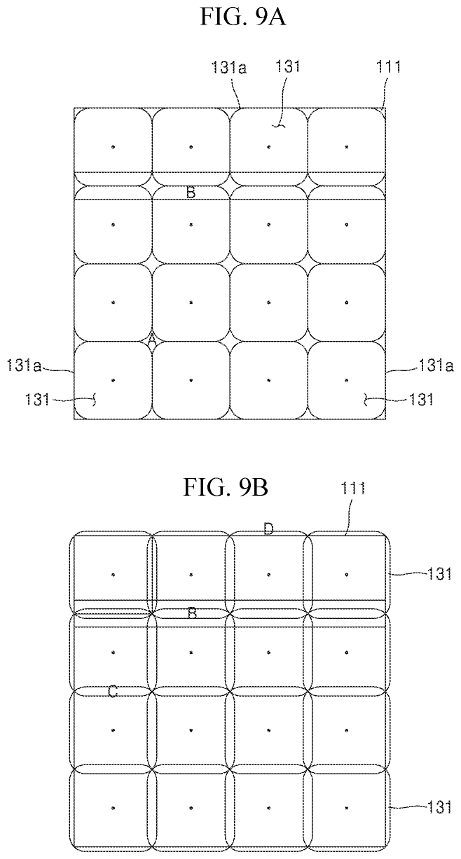

When each corner of the scrubber 110 having a rectangular shape contacts the side 131a of the base of the rectangular pyramid, it means that each corner of the scrubber 110 having a rectangular shape is covered by the side 131a of the base of the rectangular pyramid. As shown in FIG. 9A, the rectangular cross-section 111 of the scrubber 110 having a rectangular shape may be covered by the base 131 of the rectangular pyramid.

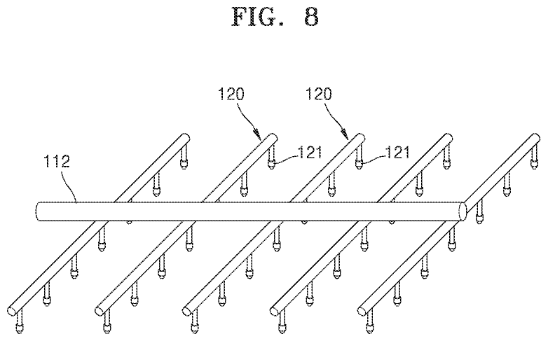

Referring to FIG. 8, in order to cause each corner of the scrubber 110 having a rectangular shape to contact the side 131a of the base of the rectangular pyramid as described above, a plurality of injectors 120 including a plurality of spray nozzles 121 may be provided. Because the plurality of injectors 120 having the same length may be formed and may be mounted on the scrubber 110 through the header pipe 112, the plurality of injectors 120 may be arranged in the same plane. (The header pipe 112, and the plurality of injectors 120 including the plurality of spray nozzles 121 for spraying a liquid in a rectangular pyramid shape constitute a spray apparatus having a rectangular pyramid shape.)

That is, as shown in FIGS. 9A and 9B, a liquid spray area is formed in a rectangular cross-section through the plurality of injectors 120 having the same length and arranged in the same plane, and a plurality of bases 131 of rectangular pyramids formed through the spray nozzles 121 are located in the rectangular cross-section to cover the rectangular cross-section 111 of the scrubber having a rectangular shape.

When the cross-section of the scrubber having a rectangular shape is covered through the plurality of injectors 120 as described above, the bases 131 of the rectangular pyramids formed by liquids sprayed by the plurality of spray nozzles 121 may not overlap one another as shown in FIG. 9A, or the bases 131 of the rectangular pyramids formed by liquids sprayed by the plurality of spray nozzles 121 may overlap one another as shown in FIG. 9B.

When the bases 131 of the rectangular pyramids formed by liquids sprayed by the plurality of spray nozzles 121 do not overlap one another as shown in FIG. 9A, it is preferable that a separation space between the bases 131 of the rectangular pyramids formed by the liquids sprayed by the plurality of spray nozzles 121 is less than 10% of an area of the bases 131 of the rectangular pyramids formed by the liquids sprayed by the spray nozzles 121.

The separation space refers to a space not covered by the liquids. When the separation space exceeds 10% of the area of the bases 131 of the rectangular pyramids, the factor A in the distribution quality excessively increases and contact efficiency between a liquid and a gas rapidly decreases.

Because the spray apparatus for improving the performance of a rectangular-shaped scrubber according to an embodiment of the present disclosure uses the spray nozzle 121 for spraying a liquid in the rectangular pyramid shape 130 to the scrubber 110 having a rectangular shape as shown in FIG. 9A and causes each corner of the scrubber 110 having a rectangular shape to be covered by the side surface 131a of the base of the rectangular pyramid formed by a liquid sprayed by the spray nozzle 121, contact efficiency between a liquid and a gas may be improved.

In detail, in FIG. 9A, the distribution quality of FIG. 6 is 96%, and the area D covered by a liquid sprayed to a wall surface and not effectively contacting a gas is 0% of a cross-sectional area of a scrubber. Accordingly, contact efficiency between a liquid and a gas inside the scrubber 110 may be improved and harmful substances in the gas may be efficiently removed.

Also, in order to minimize the factor A that is a space not covered by a liquid, as shown in FIG. 9B, the bases 131 of the rectangular pyramids formed by liquids sprayed by adjacent spray nozzles 121 may overlap each other. However, even when the amount of liquid used is large, in order to maximize contact efficiency between a liquid and a gas, it is preferable that the bases 131 of the rectangular pyramids formed by liquids sprayed by the plurality of spray nozzles 121 uniformly overlap each other.

A spray angle of a liquid sprayed by the spray nozzle 121 of the injector 120 according to an embodiment of the present disclosure preferably ranges from 10° to 150°, and more preferably ranges from 15° to 135°.

When a spray angle of a liquid sprayed by the spray nozzle 121 is less than 10°, the number of spray nozzles 121 provided to cover a cross-sectional area of the scrubber 110 excessively increases, resulting in an uneconomical design. When a spray angle of a liquid sprayed by the spray nozzle 121 is greater than 150°, droplets are scattered by a rising or falling gas, and thus, it is difficult for the droplets dispersed by the spray nozzle 121 to fall while forming the designed rectangular pyramid shape 130.

Accordingly, a spray angle of a liquid sprayed by the spray nozzle 121 preferably ranges from 10° to 150°, and more preferably ranges from 15° to 135°. A spray angle of a liquid sprayed by the spray nozzle 121 may be defined as an angle formed between one side surface of a rectangular pyramid and the other side surface viewed from the one side surface as shown in FIG. 3B.

An injection pressure at which a liquid is sprayed by the injector 120 according to an embodiment of the present disclosure preferably ranges from 0.1 bar to 30 bar, and more preferably ranges from 0.4 bar to 20 bar.

When an injection pressure at which a liquid is sprayed by the spray nozzle 21 is less than 0.1 bar, the liquid may not be sprayed as appropriate droplets. When an injection pressure at which a liquid is sprayed by the spray nozzle 121 is greater than 30 bar, excessive power is used and thus, it is uneconomical in operation.

Accordingly, an injection pressure at which a liquid is sprayed by the spray nozzle 121 of the injector 120 preferably ranges from 0.1 bar to 30 bar, and more preferably ranges from 0.4 bar to 20 bar.

The injector 120 according to an embodiment of the present disclosure may spray a liquid upward, and may spray a liquid downward. A direction in which a liquid is sprayed by the injector 120 may change according to a method of introducing a gas into the scrubber 110 and a method of removing harmful substances in the gas in the scrubber 110.

Also, the injector 120 according to an embodiment of the present disclosure may include a first injector for spraying a liquid upward and a second injector for spraying a liquid downward, and may simultaneously spray a liquid upward and downward by using the first injector and the second injector.

The injector 120 according to an embodiment of the present disclosure may be mounted on the scrubber 10 while forming a plurality of layers. In detail, a plurality of injectors 120 may form one layer while forming one plane, or another plurality of injectors 120 may form another layer while forming another plane.

A separate element for removing harmful substances may be provided in the scrubber 110 according to an embodiment of the present disclosure. In detail, the scrubber 110 may include a filler or a tray for removing harmful substances. In this case, a distance between the spray nozzle 121 and the filler or the tray is preferably greater than 0.1 m, and more preferably equal to or greater than 0.15 m.

When a distance between the spray nozzle 121 and the filler or the tray is too small (less than 0.1 m), a liquid bounces back due to impact when droplets reach the filler or the tray, and thus, the liquid is unlikely to be distributed as designed. Accordingly, a distance between the spray nozzle 121 and the filler or the tray is preferably greater than 0.1 m, and more preferably, equal to or greater than 0.15 m.

Also, a distance between the spray nozzle 121 and the filler or the tray is preferably less than 3.0 m, and more preferably, equal to or less than 1.5 m.

When a distance between the spray nozzle 121 and the filler or the tray is too large (greater than 3.0 m), a shape of the base 131 of the rectangular pyramid formed by a liquid sprayed by the spray nozzle 121 may not be a rectangular shape as intended, and thus, the liquid is unlikely to be distributed as designed. Accordingly, a distance between the spray nozzle 121 and the filler or the tray is preferably less than 3.0 m, and more preferably, equal to or less than 1.5 m.

A liquid may be formed on a lower portion 113 of the scrubber 110 according to an embodiment of the present disclosure. In this case, when there is no filler or tray at a distance between the spray nozzle 121 and a liquid surface, a distance between the spray nozzle 121 and the liquid surface is preferably greater than 0.3 m, and more preferably, equal to or greater than 0.5 m.

When a distance between the spray nozzle 121 and the liquid surface is too small (less than 0.3 m), an interval where a liquid sprayed by the spray nozzle 121 and a gas contact each other is reduced, and thus, contact efficiency between the liquid and the gas is rapidly reduced. Accordingly, a distance between the spray nozzle 121 and the liquid surface is preferably greater than 0.3 m, and more preferably, equal to or greater than 0.5 m.

The lower portion 113 of the scrubber 110 according to an embodiment of the present disclosure may not include a liquid, and there may be a bottom of the scrubber 110 or a liquid outlet. Even in this case, a distance between the spray nozzle 121 and the bottom of the lower portion 113 of the scrubber 110 or the liquid outlet is preferably greater than 0.3 m, and more preferably, equal to or greater than 0.5 m.

When a distance between the spray nozzle 121 and the bottom of the lower portion 113 of the scrubber 110 or the liquid outlet on the lower portion 113 of the scrubber 110 is too small (less than 0.3 m), an interval where a liquid sprayed by the spray nozzle 121 and a gas contact each other is reduced, and thus, contact efficiency between the liquid and the gas is rapidly reduced. Accordingly, a distance between the spray nozzle 121 and the bottom of the lower portion 113 of the scrubber 110 or the liquid outlet is preferably greater than 0.3 m, and more preferably, equal to or greater than 0.5 m.

Also, a distance between the spray nozzle 121 and the liquid surface is preferably less than 3.0 m, and more preferably, equal to or less than 1.5 m.

When a distance between the spray nozzle 121 and the liquid surface is too large (greater than 3.0 m), a shape of the base 131 of the rectangular pyramid formed by a liquid sprayed by the spray nozzle 121 may not be a rectangular shape as intended, and thus, the liquid is unlikely to be distributed as designed. Accordingly, a distance between the spray nozzle 121 and the liquid surface is preferably less than 3.0 m, and more preferably, equal to or less than 1.5 m.

In order to confirm the effect of the spray apparatus for improving the performance of a rectangular-shaped scrubber according to an embodiment of the present disclosure, the efficiency of removing harmful substances of an embodiment of FIG. 9A using the spray nozzle 121 for spraying a liquid in a rectangular pyramid shape to the scrubber 110 having a rectangular shape and the efficiency of removing harmful substances of a comparative example of FIG. 5B using the spray nozzle 21 for spraying a liquid in a conical shape to the scrubber 110 having a rectangular shape were compared with each other.

In detail, the performance for removing SO₂ when calculating based on exhaust gas including SO₂ generated in a coal-fired power plant was compared as follows. The performance was compared in a state where the gas component other than SO₂ was N₂, and the amount of liquid sprayed and the area covered by the spray nozzle 21 for spraying a liquid in one conical shape and the amount of liquid sprayed and the area covered by the spray nozzle 21 for spraying a liquid in one rectangular pyramid shape were the same.

A volume occupied by SO₂ in a total gas volume was ignored, and the amount of N₂ absorbed by water was ignored. Also, because the amount of liquid particles sprayed by a spray nozzle is proportional to a volumetric flow rate of a liquid sprayed by the spray nozzle, a ratio of the amount of liquid particles was calculated as a ratio of the amount of sprayed liquid.

Scrubber inlet gas—mass flow rate: 3,000 kg/hr, temperature: 35° (after Quencher), specific gravity: 1.14 kg/m3, volumetric flow rate: 2,632 m³/hr, SO₂ concentration: 200 mg/m3, the amount of SO₂ introduced per hour: 200 mg/m³×2,632 m³/hr=526,400 mg/hr

Scrubber cleaning solution (water)—mass flow rate: 30,000 kg/hr, temperature: 35°, specific gravity: 984 kg/m3, volumetric flow rate: 30.5 m3/hr

Scrubber specification—rectangular scrubber: 1,064 mm×1,064 mm, Sectional area: 1.132 m², the number of spray nozzles mounted on a spray apparatus: 16, the amount of water sprayed by each spray nozzle: 1.9 m³/hr (31.8 l/min), water injection pressure of each spray nozzle: 0.4 bar

### COMPARATIVE EXAMPLE

Comparative example (FIG. 5B) using the spray nozzle 21 for spraying a liquid in a conical shape to the scrubber 110 having a rectangular shape—spray angle b: 72°, effective distance a: 203.4 mm, coverage c: 295.6 mm Diameter, cover area: 0.0686 m²/EA, an area A not covered by a sprayed liquid: 0.116 m², a ratio B of the area not covered with respect to a cross-sectional area of the scrubber: 0.116 m²/1.132 m²=10.24%, the amount of gas exiting the area A not covered by the sprayed liquid: 2,632 m³/hr×10.24%=269.5 m³/hr, the amount D of liquid being sprayed to a wall of the scrubber and being not effective: 0.021 m², 1.9 m³/hr×0.021 m²/ 0.0686 m²=0.58 m³/hr, the amount C of liquid in which particles sprayed by adjacent nozzles overlap and are not effective: 0.062 m², 1.9 m³/hr×0.062 m²/0.0686 m²=1.717 m³/hr, the amount of effective liquid: 30.5 m³/hr−0.58 m³/hr−1.717 m³/hr=28.203 m³/hr (92.5%), the amount of SO₂ passing through the area A: 269.5 m³/hr×200 mg/m³=53,900 mg/hr, SO₂ concentration in an exhaust gas due to SO₂ passing through the area A: 53,900 mg/2,632 m³=20 mg/m³.

### Embodiment

Embodiment (FIG. 9A) using the spray nozzle 121 for spraying a liquid in a rectangular pyramid shape to the scrubber 110 having a rectangular shape—spray angle b: 75°, effective distance a: 173.3 mm, coverage c: 266 mm×266 mm, cover area: 0.0686 m²/EA, an area A not covered by a sprayed liquid: 0.034 m², a ratio B of the area not covered with respect to a cross-sectional area of the scrubber: 0.034 m²/1.132 m²=3.0%, the amount of gas exiting the area not covered by the sprayed liquid: 2,632 m³/hr×3.0%=79 m³/hr, the amount D of liquid sprayed to a wall of the scrubber and being not effective: 0.0 m³/hr, the amount C of liquid in which particles sprayed by adjacent nozzles overlap and are not effective: 0.0 m³/hr, the amount of effective liquid: 30.5 m³/hr, the amount of SO₂ passing through the area A: 79 m³/hr×200 mg/m³=15,800 mg/hr, SO₂ concentration in an exhaust gas due to SO₂ passing through the area A: 15,800 mg/2,632 m³=6 mg/m³.

Because a SO₂ concentration in an exhaust gas when the spray nozzle 121 for spraying a liquid in a rectangular pyramid shape to the scrubber 110 having a rectangular shape is used is 6 mg/m³ whereas a SO₂ concentration in an exhaust gas when the spray nozzle 21 for spraying a liquid in a conical shape to the scrubber 110 having a rectangular shape is used is 20 mg/m³, harmful substances in an exhaust gas may be efficiently removed when the spray nozzle 121 for spraying a liquid in a rectangular pyramid shape to the scrubber 110 having a rectangular shape is used.

The spray apparatus for improving the performance of a rectangular-shaped scrubber according to an embodiment of the present disclosure has the following effects.

In the spray apparatus for improving the performance of a rectangular-shaped scrubber according to an embodiment of the present disclosure, because the injector 120 for spraying a liquid in the rectangular pyramid shape 130 is mounted on the scrubber 110 having a rectangular shape, harmful substances in a gas may be efficiently removed.

Also, in the spray apparatus for improving the performance of a rectangular-shaped scrubber according to an embodiment of the present disclosure, because the injector 120 for spraying a liquid in the rectangular pyramid shape 130 is mounted on the scrubber 110 having a rectangular shape, a portion of the scrubber 110 not covered by the liquid sprayed by the injector 120 may be minimized.

Also, in the spray apparatus for improving the performance of a rectangular-shaped scrubber according to an embodiment of the present disclosure, because the injector 120 for spraying a liquid in the rectangular pyramid shape 130 is mounted on the scrubber 110 having a rectangular shape, an area where liquids sprayed by the plurality of injectors 120 overlap one another may be minimized, a liquid sprayed onto an inner wall surface of the scrubber 110 may be minimized, contact efficiency between a liquid and a gas may be improved, and, thus, harmful substances may be efficiently removed.

Also, the spray apparatus for improving the performance of a rectangular-shaped scrubber according to an embodiment of the present disclosure may be applied to various columns such as an absorption tower or a washing tower for chemical reactions, and may be applied to various fields as long as it may remove harmful substances in a gas while the gas is injected.

While the present disclosure has been particularly shown and described with reference to embodiments thereof, they are provided for the purposes of illustration and it will be understood by one of ordinary skill in the art that various modifications and equivalent other embodiments made be made from the present disclosure. Accordingly, the true technical scope of the present disclosure is defined by the technical spirit of the appended claims.

1. A spray apparatus for improving the performance of a rectangular-shaped scrubber to remove harmful substances of a gas, the spray apparatus comprising:
a scrubber having a rectangular shape; and
an injector mounted on the scrubber and comprising a spray nozzle configured to spray a liquid in a rectangular pyramid shape.

2. The spray apparatus of claim 1, wherein each of corners of the scrubber having the rectangular shape contacts a side of a base of a rectangular pyramid formed by a liquid sprayed by the injector.

3. The spray apparatus of claim 1, wherein the injector comprises a plurality of spray nozzles,
wherein a plurality of injectors are provided, and the plurality of injectors are arranged in a same plane.

4. The spray apparatus of claim 3, wherein a separation space between bases of rectangular pyramids formed by liquids spayed by the plurality of spray nozzles is less than 10% of an area of the bases of the rectangular pyramids formed by the liquids sprayed by the plurality of spray nozzles.

5. The spray apparatus of claim 3, wherein bases of rectangular pyramids formed by liquids sprayed by adjacent spray nozzles overlap one another.

6. The spray apparatus of claim 1, wherein a spray angle of a liquid sprayed by the spray nozzle of the injector ranges from 10° to 150°.

7. The spray apparatus of claim 1, wherein the injector is configured to spray a liquid upward or downward.

8. The spray apparatus of claim 7, wherein the injector comprises a first injector configured to spray a liquid upward and a second injector configured to spray a liquid downward.

9. The spray apparatus of claim 1, wherein the scrubber comprises a filler or a tray for removing harmful substances, wherein a distance between the spray nozzle and the filler or the tray is greater than 0.1 m.

10. The spray apparatus of claim 1, wherein a distance between the spray nozzle and a surface of a liquid formed on a lower portion of the scrubber is greater than 0.3 m.

11. The spray apparatus of claim 1, wherein a distance between the spray nozzle and a bottom of a lower portion of the scrubber or a liquid outlet on the lower portion of the scrubber is greater than 0.3 m.

12. The spray apparatus of claim 1, wherein a liquid injection pressure of the spray nozzle ranges from 0.1 bar to 30 bar.

13. The spray apparatus of claim 1, wherein the injector is mounted on the scrubber while forming a plurality of layers.
